(19) United States
(12) Patent Application Publication
(10) Pub. No.: US 2014/0022204 A1
(43) Pub. Date: Jan. 23, 2014

(54) POLARIZER

(71) Applicant: Tianajin Funayuanchuang Technology Co., Ltd., (US)

(72) Inventor: HO-CHIEN WU, Hsinchu (TW)

(73) Assignee: TIANJIN FUNAYUANCHUANG TECHNOLOGY CO.,LTD., Tianjin (CN)

(21) Appl. No.: 13/730,711

(22) Filed: Dec. 28, 2012

(30) Foreign Application Priority Data
Jul. 23, 2012 (CN) 2012102544379

(51) Int. Cl. G06F 3/044

(52) U.S. Cl. CPC G06F 3/044
USPC 345/174

(57) ABSTRACT

A polarizer, having touch sensing capability includes a polarizing layer, a transparent conducive layer, and first driving-sensing electrodes. The transparent conducive layer and the polarizing layer are stacked with each other. The transparent conductive layer is an anisotropic impedance layer having a relatively low impedance direction and a relatively high impedance direction. The first driving-sensing electrodes are spaced with each other and arranged in a row along the relatively high impedance direction and electrically connected with the transparent conducive layer.

### CROSS-REFERENCE TO RELATED APPLICATIONS

This application claims all benefits accruing under 35 U.S.C. §119 from China Patent Application No. 201210254437.9, filed on Jul. 23, 2012 in the China Intellectual Property Office, the content of which is hereby incorporated by reference. This application is related to commonly-assigned applications entitled, “POLARIZER”, filed ______ (Atty. Docket No. US46699); “LIQUID CRYSTAL DISPLAY MODULE”, filed ______ (Atty. Docket No. US46674), “LIQUID CRYSTAL DISPLAY MODULE”, filed ______ (Atty. Docket No. US46676), “METHOD FOR MAKING LIQUID CRYSTAL DISPLAY MODULE”, filed ______ (Atty. Docket No. US46677), “METHOD FOR MAKING LIQUID CRYSTAL DISPLAY MODULE”, filed ______ (Atty. Docket No. US46702), “LIQUID CRYSTAL DISPLAY MODULE”, filed ______ (Atty. Docket No. US46700), and “LIQUID CRYSTAL DISPLAY MODULE”, filed ______ (Atty. Docket No. US46701).

### BACKGROUND

1. Technical Field

The present disclosure relates to a polarizer used in a liquid crystal display screen with touch sensing capability.

2. Description of Related Art

A conventional liquid crystal display screen for a liquid crystal display (LCD), according to the prior art, generally includes a first polarizer, a thin film transistor (TFT) panel, a first alignment layer, a liquid crystal layer, a second alignment layer, a common electrode layer (e.g., an indium tin oxide (ITO) layer), an upper board, and a second polarizer. The TFT panel includes a plurality of pixel electrodes. Polarizing directions of the first and second polarizers are perpendicular to each other. When a voltage is applied between the pixel electrode and the common electrode layer, the liquid crystal molecules in the liquid crystal layer between the first alignment layer and the second alignment layer align along a same direction to polarize the light beams by the first polarizer irradiate on the second polarizer directly without rotation, and the polarized light beams cannot pass through the first polarizer. Without a voltage applied to the pixel electrode and the common electrode layer, the polarized light beams rotated by the liquid crystal molecules can pass through the second polarizer. Selectively applying voltages between different pixel electrodes and the common electrode layer can control the on and off of different pixels, thus displaying images.

A conventional polarizing layer is made by using a transparent polymer film (e.g., PVA film) to absorb dichroic material, to let the dichroic material infiltrated into the transparent polymer film, and extruding the transparent polymer film to align the dichroic material in one direction. A conventional polarizer includes not only the polarizing layer but also protective layers, adhesive layer, separating layer covered on two opposite surfaces of the polarizing layer. During the manufacturing of the liquid crystal display screen, the second polarizer is directly attached to a top surface of the upper board.

Following the advancement in recent years of various electronic apparatuses, such as mobile phones, car navigation systems and the like, toward high performance and diversification, there has been continuous growth in the number of electronic apparatuses equipped with optically transparent touch panels in front of their respective display devices (e.g., liquid crystal display screen). The touch panel is commonly attached to the top surface of the second polarizer. However, this arrangement will increase a thickness of the electronic apparatuses. Further, the touch panel and the second polarizer are individually manufactured and assembled, which increases the complication of the manufacturing process, and increases a cost for production.

What is needed, therefore, is to provide a polarizer capable of sensing touches occurred thereon meanwhile polarizing lights, thus the liquid crystal display screen using the polarizer does not need to have a separate touch panel.

### BRIEF DESCRIPTION OF THE DRAWING

Many aspects of the present disclosure can be better understood with reference to the following drawings. The components in the drawings are not necessarily to scale, the emphasis instead being placed upon clearly illustrating the principles of the present embodiments.

FIG. 1 is a side view of an embodiment of a polarizer.

FIG. 2 is a top view of an embodiment of a transparent conductive layer of the polarizer.

FIG. 3 shows a Scanning Electron Microscope (SEM) image of a carbon nanotube film.

FIG. 4 is a structural schematic view of an embodiment of a carbon nanotube segment in the carbon nanotube film.

FIG. 5 is a side view of another embodiment of a polarizer.

FIG. 6 is a side view of yet another embodiment of a polarizer.

FIG. 7 is a side view of yet another embodiment of a polarizer.

FIG. 8 is a top view of another embodiment of a transparent conductive layer of the polarizer.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean at least one.

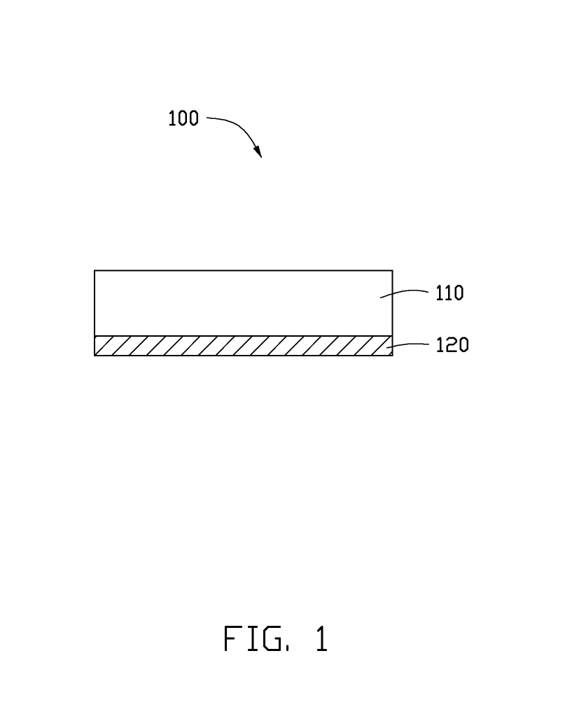

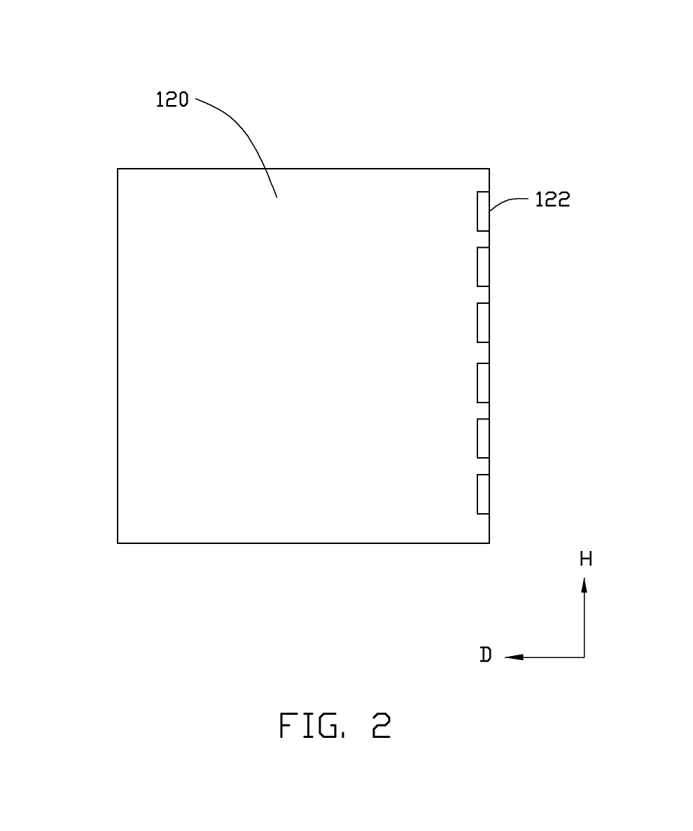

Referring to FIG. 1 and FIG. 2, one embodiment of a polarizer 100 is capable of sensing touches and polarizing lights and includes a polarizing layer 110, a transparent conducive layer 120, and a plurality of first driving-sensing electrodes 122. The polarizer 100 is suitable for a touch sensing type liquid crystal display screen, and it is especially suitable for being used as an upper polarizer (i.e., the second polarizer) in the touch sensing type liquid crystal display screen. The transparent conducive layer 120 and the polarizing layer 110 are stacked. The plurality of first driving-sensing electrodes 122 are spaced with each other and electrically connected with the transparent conducive layer 120.

The polarizing layer 110 can be an insulating material layer having a light polarizing function. More specifically, the polarizing layer 110 includes a transparent polymer film (e.g., PVA film) and a dichroism material infiltrated in the transparent polymer film. The dichroism material can be iodoquinine sulfate. The molecules of the dichroism material can align along the same direction.

The transparent conductive layer 120 can be directly in contact with the surface of the polarizing layer 110. The transparent conductive layer 120 can be an anisotropic impedance layer. In the present disclosure, the anisotropic impedance means a structure having a relatively low impedance direction D and a relatively high impedance direction H on the same surface (e.g., the surface of the transparent conductive layer 120). The electrical conductivity of the anisotropic impedance layer on the relatively high impedance direction H is smaller than the electrical conductivities of the anisotropic impedance layer on other directions. The electrical conductivity of the anisotropic impedance layer on the relatively low impedance direction D is larger than the electrical conductivities of the anisotropic impedance layer in other directions. The relatively high impedance direction H is different from the relatively low impedance direction D. In one embodiment, the relatively high impedance direction H is perpendicular to the relatively low impedance direction D. The relatively high impedance direction H and the relatively low impedance direction D of the anisotropic impedance layer can be achieved by having a plurality of conductive belts having a low conductivity aligned along the relatively high impedance direction H and a plurality of conductive belts having a high conductivity aligned along the relatively low impedance direction D, and the plurality of conductive belts having the low conductivity and the plurality of conductive belts having the low conductivity are electrically connected with each other. In another embodiment, the relatively high impedance direction H and the relatively low impedance direction D of the anisotropic impedance layer can be achieved by having a carbon nanotube film comprising orderly arranged carbon nanotubes. The transparent conductive layer 120 can have a square shape having two sides perpendicular to the relatively high impedance direction H and two sides perpendicular to the relatively low impedance direction D.

The plurality of first driving-sensing electrodes 122 spaced with each other and arranged in a row along the relatively high impedance direction H. More specifically, the plurality of first driving-sensing electrodes 122 are arranged on the side of the transparent conductive layer 120, perpendicular to the relatively low impedance direction D. A length along the relatively high impedance direction H of each first driving-sensing electrode 122 can be between about 1 mm to about 8 mm. A distance between the two adjacent first driving-sensing electrodes 122 can be between about 3 mm to about 5 mm. A signal input by each first driving-sensing electrode 122 to the transparent conductive layer 120, or received from the transparent conductive layer 120, will transmit primarily along the relatively low impedance direction D. The directional characteristic of the signal transmittance in the transparent conductive layer 120 can be used as a determining basis for the polarizer 100 to determine a touch location. It is to be understood that the size and pitch of the first driving-sensing electrodes 122 can change depending on the desired resolution and application. The first driving-sensing electrodes 122 can be located on the surface of the transparent conductive layer 120, near the side. The first driving-sensing electrodes 122 can be formed by screen printing, sputtering, evaporating, or coating methods. The transparent conductive layer 120 and the plurality of first driving-sensing electrodes 122 cooperatively form a touch control module.

In one embodiment, the transparent conductive layer 120 includes the carbon nanotube film comprising the plurality carbon nanotubes orderly arranged. The plurality of carbon nanotubes are substantially aligned along a same direction so that the carbon nanotube film has a maximum electrical conductivity at the aligned direction of the carbon nanotubes which is greater than at other directions. The aligned direction of the plurality of carbon nanotubes is the relatively low impedance direction D. The carbon nanotube film can be formed by drawing the film from a carbon nanotube array. The overall aligned direction of a majority of the carbon nanotubes in the carbon nanotube film is substantially aligned along the same direction and parallel to a surface of the carbon nanotube film. The carbon nanotube is joined to adjacent carbon nanotubes end to end by van der Waals force therebetween, and the carbon nanotube film is capable of being a free-standing structure. A support having a large surface area to support the entire free-standing carbon nanotube film is not necessary, and only a supportive force at opposite sides of the film is sufficient. The free-standing carbon nanotube film can be suspended and maintain its own film state with only supports at the opposite sides of the film. When disposing (or fixing) the carbon nanotube film between two spaced supports, the carbon nanotube film between the two supports can be suspended while maintaining its integrity. The successively and aligned carbon nanotubes joined end to end by van der Waals attractive force in the carbon nanotube film is the main reason for the free-standing property. The carbon nanotube film drawn from the carbon nanotube array has a good transparency. In one embodiment, the carbon nanotube film is substantially a pure film and consists essentially of the carbon nanotubes, and to increase the transparency of the touch panel, the carbon nanotubes are not functionalized. The free-standing carbon nanotube film can be directly attached to the surface of the polarizing layer.

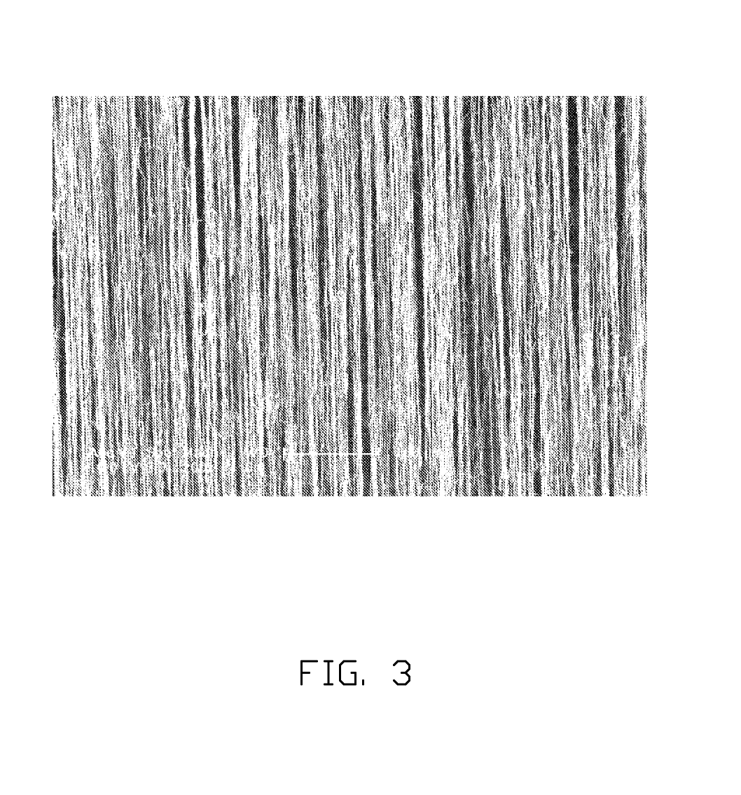

Referring to FIG. 3, the plurality of carbon nanotubes in the carbon nanotube film have a preferred orientation along the same direction. The preferred orientation means that the overall aligned direction of the majority of carbon nanotubes in the carbon nanotube film is substantially along the same direction. The overall aligned direction of the majority of carbon nanotubes is substantially parallel to the surface of the carbon nanotube film, thus parallel to the surface of the polarizing layer. Furthermore, the majority of carbon nanotubes are joined end to end therebetween by van der Waals force. In this embodiment, the majority of carbon nanotubes are substantially aligned along the same direction in the carbon nanotube film, with each carbon nanotube joined to adjacent carbon nanotubes at the aligned direction of the carbon nanotubes end to end by van der Waals force. There may be a minority of carbon nanotubes in the carbon nanotube film that are randomly aligned, but the number of randomly aligned carbon nanotubes is very small compared to the majority of substantially aligned carbon nanotubes and therefore will not affect the overall oriented alignment of the majority of carbon nanotubes in the carbon nanotube film.

In the carbon nanotube film, the majority of carbon nanotubes that are substantially aligned along the same direction may not be completely straight. Sometimes, the carbon nanotubes can be curved or not exactly aligned along the overall aligned direction, and can deviate from the overall aligned direction by a certain degree. Therefore, it cannot be excluded that partial contacts may exist between the juxtaposed carbon nanotubes in the majority of carbon nanotubes aligned along the same direction in the carbon nanotube film. Despite having curved portions, the overall alignment of the majority of the carbon nanotubes are substantially aligned along the same direction.

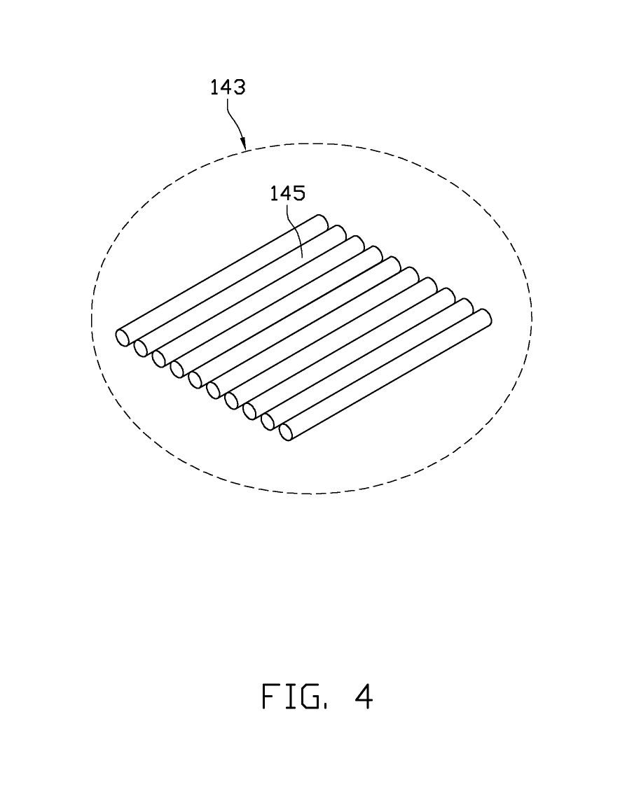

Referring to FIG. 4, the carbon nanotube film includes a plurality of successive and oriented carbon nanotube segments 143. The plurality of carbon nanotube segments 143 are joined end to end by van der Waals attractive force. Each carbon nanotube segment 143 includes a plurality of carbon nanotubes 145 that are substantially parallel to each other, and the plurality of parallel carbon nanotubes 145 are in contact with each other and combined by van der Waals attractive force therebetween. The carbon nanotube segment 143 can have a desired length, thickness, uniformity, and shape. The carbon nanotubes 145 in the carbon nanotube film have a preferred orientation along the same direction. The carbon nanotube wires in the carbon nanotube film can consist of a plurality of carbon nanotubes joined end to end. The adjacent and juxtaposed carbon nanotube wires can be connected by the randomly aligned carbon nanotubes. There can be clearances between adjacent and juxtaposed carbon nanotubes in the carbon nanotube film. A thickness of the carbon nanotube film at the thickest location is about 0.5 nanometers to about 100 microns (e.g., in a range from 0.5 nanometers to about 10 microns).

A method for drawing the carbon nanotube film from the carbon nanotube array includes: (a) selecting a carbon nanotube segment 143 from a carbon nanotube array using a drawing tool, such as an adhesive tape or adhesive substrate bar contacting the carbon nanotube array, to select the carbon nanotube segment 143; and (b) moving the drawing tool and drawing the selected carbon nanotube segment 143 at a certain speed, such that a plurality of carbon nanotube segments 143 are drawn joined end to end, thereby forming a successive carbon nanotube film. The plurality of carbon nanotubes of the carbon nanotube segment 143 are juxtaposed to each other. While the selected carbon nanotube segment 143 gradually separates from the growing substrate of the carbon nanotube array along the drawing direction under the drawing force, the other carbon nanotube segments 143 that are adjacent to the selected carbon nanotube segment 143 are successively drawn out end to end under the action of the van der Waals force, thus forming a successive and uniform carbon nanotube film having a width and preferred orientation.

The carbon nanotube film has a unique impedance property because the carbon nanotube film has a minimum electrical impedance in the drawing direction, and a maximum electrical impedance in the direction perpendicular to the drawing direction, thus the carbon nanotube film has an anisotropic impedance property. A relatively low impedance direction D is the direction substantially parallel to the aligned direction of the carbon nanotubes, and a relatively high impedance direction H is substantially perpendicular to the aligned direction of the carbon nanotubes. The carbon nanotube film can have a square shape with four sides. Two sides are opposite to each other and substantially parallel to the relatively high impedance direction H. The other two sides are opposite to each other and substantially parallel to the relatively low impedance direction D. In one embodiment, a ratio between the impedance at the relatively high impedance direction H and the impedance at the relatively low impedance direction D of the carbon nanotube film is equal to or greater than 50 (e.g., in a range from 70 to 500).

The transparent conductive layer 120 can include a plurality of carbon nanotube films laminated to each other or arranged side to side. The carbon nanotubes in the plurality of carbon nanotube films are aligned along the same direction. The carbon nanotube film can have a transmittance of visible light above 85%.

Because the carbon nanotubes can absorb the part of the lights having the polarizing direction parallel to the carbon nanotubes, the relatively low impedance direction D is arranged parallel to the polarizing direction of the polarizing layer 110.

In one embodiment, the driving mode of the transparent conductive layer 120 is progressive scanning the first driving-sensing electrodes 122 to receive the sensing signals from the first driving-sensing electrodes 122. The progressive scanning means that the first driving-sensing electrodes 122 are scanned by a scanning circuit group by group or one by one. During the scanning of one first driving-sensing electrode 122, the scanned first driving-sensing electrode 122 is electrically connected to the scanning circuit, and all the other first driving-sensing electrodes 122 are electrically grounded. The sensing signals received from three adjacent first driving-sensing electrodes 122 are compared with each other to calculate the touch position on the direction perpendicular to the relatively low impedance direction D. The touch position on the relatively low impedance direction D is determined by using the values of the sensing signals received from all the first driving-sensing electrodes 122. The scanning circuit can include a charging circuit (e.g. including a voltage source), a storage circuit (e.g., including an external capacitance (Cout), and a readout circuit. When the polarizer 100 is touched by a touch tool (e.g., a conductive substance such as fingers), a contact capacitance can be formed between the touch tool and the transparent conductive layer 120. The scanning circuit can charge the contact capacitance formed between the touch tool and the transparent conductive layer 120, read the value of the contact capacitance, and store the value of the contact capacitance. The charging circuit and the storage circuit are connected in parallel, and the readout circuit is connected to the storage circuit. More specifically, the first driving-sensing electrode 122 being scanned is alternately connected to the charging circuit and the storage circuit, thus the contact capacitance is charged by the charging circuit and then discharged by the storage circuit. The readout circuit can then read the charging amount of the contact capacitance, such as reading a voltage value, to be a determining basis of the touch location. The voltage value can be stored in the storage circuit. After all the first driving-sensing electrodes 122 are scanned one by one or group by group, the voltage values corresponded to different first driving-sensing electrodes 122 can be compared, and the one or several largest voltage values can be selected. The position of the touch or touches on the relatively high impedance direction H can be determined by the location of the one or several first driving-sensing electrodes 122 having the one or several largest voltage values. The voltage values can be used to determine the position of the touches on the relatively low impedance direction D.

Due to the anisotropic impedance property of the carbon nanotube film, the sensing signals received from the first driving-sensing electrodes 122 can directly reflect the near or far from the touch position to the first driving-sensing electrodes 122. Thus, the polarizer 100 has a relatively good sensing accuracy. Further, the polarizer 100 can detect the touch position by directly reading the values of the sensing signals and comparing the values of adjacent sensing signals. Therefore, a complicated driving circuit and method for calculating the touch position are not necessary. Overall, the polarizer 100 uses a simple structure to accomplish the touch sensing in a relatively high accuracy, and does not need a complicated driving circuit.

The polarizer 100 can further include a conducting wire (not shown), to electrically connect the first driving-sensing electrodes 122 to the outer circuit. The conducting wire can be arranged around the transparent conductive layer 120 with the first driving-sensing electrodes 122.

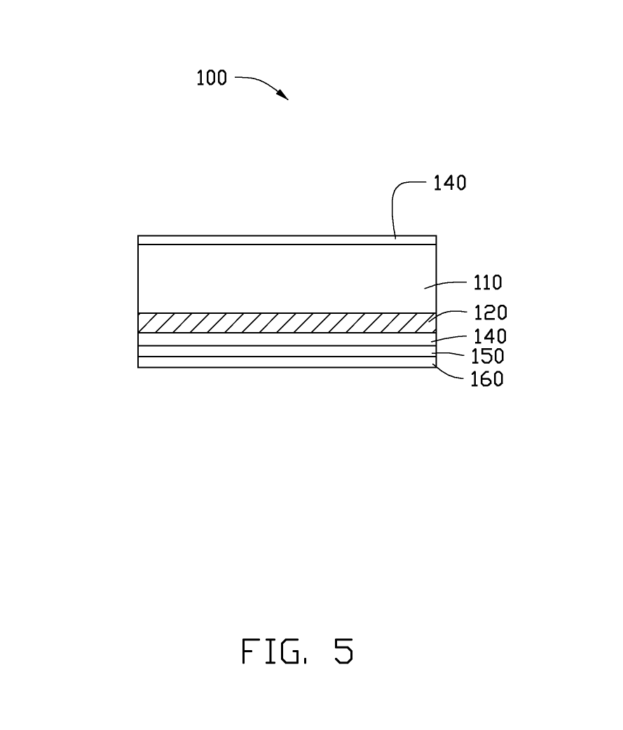

Referring to FIG. 5, the polarizer 100 can further include at least one of a protective layer 140, an adhesive layer 150, and a release layer 160. The protective layer 140 is used to protect the polarizing layer 110 and the transparent conductive layer 120. The adhesive layer 150 is used to combine the polarizer 100 to an upper board of a liquid crystal display screen. The release layer 160 is used to protect the adhesive layer 150, and can be released or peeled from the adhesive layer 150 to contact the adhesive layer 150 to the upper board of the liquid crystal display screen. The material of the protective layer 140 can be at least one of triacetyl cellulose (TAC), polystyrene, polyethylene, polyethylene terephthalate (PET), poly(methyl methacrylate) (PMMA), polycarbonate (PC), and benzocyclobutene (BCB). The material of the adhesive layer 150 can be UV adhesive, pressure sensitive adhesive, or thermal sensitive adhesive.

The polarizing layer 110 can solely form a polarizer main body, or cooperatively form the polarizer main body with at least one of the protective layer 140, the adhesive layer 150, and the release layer 160. The transparent conductive layer 120 can be arranged on a surface of the polarizer main body, or inserted into the polarizer main body.

In one embodiment, the polarizer 100 includes two protective layers 140 respectively attached to the surface of the transparent conductive layer 120 and the surface of the polarizing layer 110, to sandwich the transparent conductive layer 120 and the polarizing layer 110 between the two protective layers 140. The transparent conductive layer 120 and the polarizing layer 110 are located between the two protective layers 140. The adhesive layer 150 is arranged on the surface of the protective layer 140 which is near to the transparent conductive layer 120. The release layer 160 covers the outer surface of the adhesive layer 150.

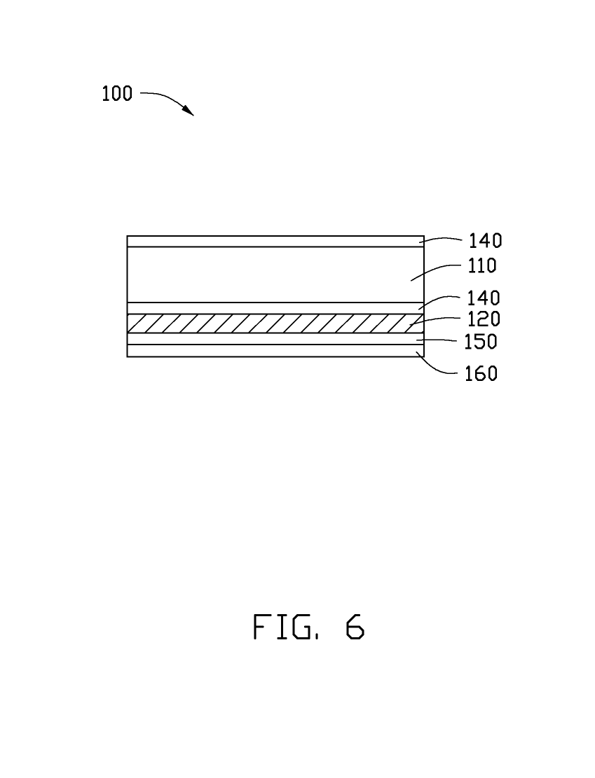

Referring to FIG. 6, in another embodiment, the polarizer 100 includes two protective layers 140 respectively attached to the two surfaces of the polarizing layer 110, to sandwich the polarizing layer 110 between the two protective layers 140. The polarizing layer 110 is located between the two protective layers 140. The transparent conductive layer 120 is arranged on the outer surface of one of the two protective layers 140. The one of the two protective layers 140 is located between the transparent conductive layer 120 and the polarizing layer 110. The adhesive layer 150 is arranged on the outer surface of the transparent conductive layer 120, to sandwich the transparent conductive layer 120 between the adhesive layer 150 and the protective layer 140. The release layer 160 covers the outer surface of the adhesive layer 150.

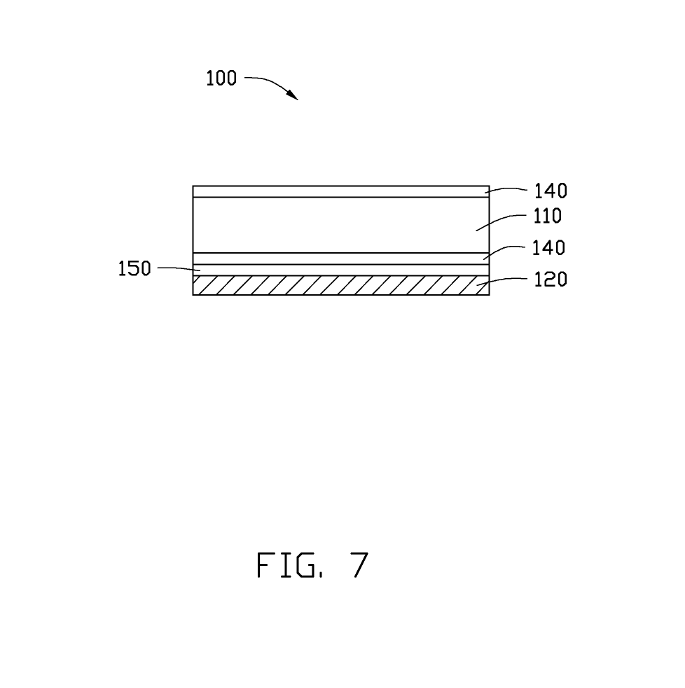

Referring to FIG. 7, in yet another embodiment, the polarizer 100 includes two protective layers 140 respectively attached to the two surfaces of the polarizing layer 110, to sandwich the polarizing layer 110 between the two protective layers 140. The adhesive layer 150 is arranged on the outer surface of one of the two protective layers 140. The transparent conductive layer 120 is arranged on the outer surface of the adhesive layer 150, to sandwich the adhesive layer 150 between the transparent conductive layer 120 and the protective layer 140.

In the above described embodiments, the transparent conductive layer 120 can be the freestanding carbon nanotube film having the anisotropic impedance property. The polarizer 100 can use only the single carbon nanotube film to sense the multi-touch. The freestanding carbon nanotube film can be formed independently from the other parts of the polarizer 100, and further attached to the needing surface in the polarizer 100.

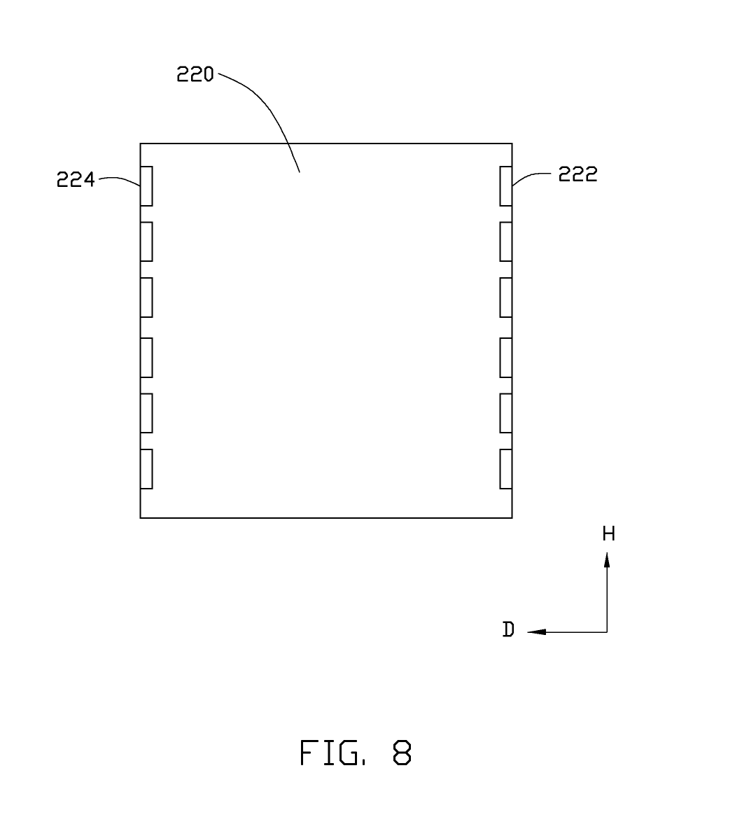

Referring to FIG. 8, in yet another embodiment, the polarizer includes a polarizing layer, a transparent conductive layer 220, a plurality of first driving-sensing electrodes 222 and a plurality of second driving-sensing electrodes 224. The polarizer in this embodiment is similar to the polarizer 100, except that the plurality of second driving-sensing electrodes 224 are spaced with each other and arranged in a row along the relatively high impedance direction H to electrically connect with the transparent conducive layer 220. More specifically, the plurality of second driving-sensing electrodes 224 are arranged on the side of the transparent conductive layer 220 perpendicular to the relatively low impedance direction D. The plurality of first driving-sensing electrodes 222 and a plurality of second driving-sensing electrodes 224 are arranged in a one to one manner.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A polarizer, having touch sensing capability, comprising:
a polarizing layer;
a transparent conducive layer, the transparent conducive layer and the polarizing layer being stacked with each other, the transparent conductive layer being an anisotropic impedance layer having a relatively low impedance direction and a relatively high impedance direction; and
a plurality of first driving-sensing electrodes being spaced with each other and arranged in a row along the relatively high impedance direction and electrically connected with the transparent conducive layer.

2. The polarizer of claim 1, wherein the relatively high impedance direction is perpendicular to the relatively low impedance direction.

3. The polarizer of claim 2, wherein the plurality of first driving-sensing electrodes are arranged on a side of the transparent conductive layer and the side is perpendicular to the relatively low impedance direction.

4. The polarizer of claim 1, wherein the transparent conductive layer comprises a carbon nanotube film, a majority of carbon nanotubes in the carbon nanotube film is substantially aligned along the relatively low impedance direction.

5. The polarizer of claim 4, wherein the majority of carbon nanotubes are joined end to end by van der Waals attractive force therebetween.

6. The polarizer of claim 4, wherein the majority of carbon nanotubes is substantially parallel to a surface of the polarizing layer.

7. The polarizer of claim 4, wherein the carbon nanotube film is a free-standing carbon nanotube film that is directly attached to a surface of the polarizing layer.

8. The polarizer of claim 4, wherein the relatively low impedance direction is parallel to a polarizing direction of the polarizing layer.

9. The polarizer of claim 1 further comprising two protective layers, wherein the transparent conductive layer and the polarizing layer are located between the two protective layers.

10. The polarizer of claim 1 further comprising two protective layers, wherein the polarizing layer is located between the two protective layers, the transparent conductive layer is located on a surface of one of the two protective layers, the one of the two protective layers is located between the transparent conductive layer and the polarizing layer.

11. The polarizer of claim 1 further comprising two protective layers and an adhesive layer, wherein the polarizing layer is located between the two protective layers, the adhesive layer is located on a surface of one of the two protective layers, the transparent conductive layer is located on a surface of the adhesive layer, and the adhesive layer is located between the transparent conductive layer and the one of the two protective layers.

12. The polarizer of claim 1 further comprising a plurality of second driving-sensing electrodes, wherein the plurality of second driving-sensing electrodes are spaced with each other, arranged in a row along the relatively high impedance direction, and electrically connected with the transparent conducive layer.

13. The polarizer of claim 12, wherein the plurality of second driving-sensing electrodes are arranged on another side of the transparent conductive layer, perpendicular to the relatively low impedance direction, and the plurality of first driving-sensing electrodes and the plurality of second driving-sensing electrodes are arranged in a one to one manner.

14. A polarizer, having touch sensing capability, comprising:
a polarizer main body;
a transparent conducive layer located on a surface of the polarizer main body, the transparent conductive layer being an anisotropic impedance layer having a relatively low impedance direction parallel to the surface of the polarizer main body; and
a plurality of first driving-sensing electrodes located on at least one side of the transparent conducive layer, the at least one side being perpendicular to the relatively low impedance direction,
wherein the transparent conducive layer and the plurality of first driving-sensing electrodes cooperatively form a touch module, a driving method of the touch module comprises:
progressive scanning at least a portion of the plurality of first driving-sensing electrodes;
receiving sensing signals from the at least a portion of the plurality of first driving-sensing electrodes; and
comparing the sensing signals with each other to calculate a touch position on a direction perpendicular to the relatively low impedance direction and the touch position on the relatively low impedance direction.
